(19) United States
(12) Patent Application Publication
(10) Pub. No.: US 2016/0290475 A1
(43) Pub. Date: Oct. 6, 2016

(54) SHAFT-BEARING SUBASSEMBLY FOR A WIND TURBINE TRANSMISSION

(71) Applicants: ZF Friedrichshafen AG, Friedrichshafen (DE); ZF WIND POWER ANTWERPEN N.V., Lommel (BE)

(72) Inventor: Bert VERDYCK, Nijlen (BE)

(21) Appl. No.: 15/104,060

(22) PCT Filed: Nov. 18, 2014
(86) PCT No.: PCT/EP2014/074824

§ 371 Date: Jun. 13, 2016

(30) Foreign Application Priority Data
Dec. 18, 2013 (DE) 10 2013 226 519.0

(51) Int. Cl. F16H 57/021; F16C 19/54; F16H 57/023; F03D 80/70; F03D 15/00

(52) U.S. Cl. CPC F16H 57/021; F03D 80/70; F03D 15/00; F16H 57/023; F16C 19/548; F05B 2230/60; F05B 2240/60; F05B 2240/54; F16H 2057/0216; F16H 2057/0221

(57) ABSTRACT

A shaft-bearing subassembly (10) which includes at least one shaft (11) mounted by way of at least first and second roller bearings (13, 14). The first and second roller bearings (13, 14) are mounted on the at least one shaft (11) with an intermediate space between them. The first roller bearing (13) is fixed axially and the second roller bearing (14) is secured by way of a retaining element (16). The retaining element (16) is on the side of the second roller bearing (14) farthest away from the first roller bearing (13), and has a first contact surface (17) which limits the movement of an inner race (18) of the second roller bearing (14) in at least one direction, and a second contact surface (19) which is in contact with an abutment (20) on the shaft (11).

This application is a National Stage completion of PCT/EP2014/074824 filed Nov. 18, 2014, which claims priority from German patent application serial no. 10 2013 226 519.0 filed Dec. 18, 2013.

### FIELD OF THE INVENTION

The present invention concerns a shaft-bearing subassembly for a wind turbine transmission and a method for fitting roller bearings onto a shaft of a wind turbine transmission.

### BACKGROUND OF THE INVENTION

In transmissions, shafts are mounted by means of bearings so that the shafts can rotate. To be able to fix the position of the shaft in the transmission as accurately as possible, among other things movement of the bearings axially on the shaft must be prevented. Another important requirement is that the bearing play can be adjusted accurately.

At present a number of methods are known for assembling a bearing pair, for example a pair of roller bearings, on a shaft, for example from “Roller bearings in industrial transmissions” by SKF. FIG. 1 illustrates a first mechanism for adjusting a bearing arrangement with conical roller bearings in a mirror-image, back-to-back arrangement (O-arrangement). In this case a first conical roller bearing 1 is fitted at one end of a shaft 2 and a second conical roller bearing 3 at the other end of the shaft 2. The bearing play is adjusted by means of a locking nut 4. The locking nut is positioned on the side of the second conical roller bearing 3 farthest away from the first conical roller bearing 1. The locking nut 4 determines the position and hence the bearing play of the conical roller bearing 3, since the inner race 5 of the second conical roller bearing 3 does not exert any pressure against the shaft 2 or any other component. The disadvantage of such a method for adjusting the bearing play lies in the poor reproducibility of the exact bearing play adjustment, since the position of the inner race 5 of the bearing is not predetermined and depends on the fitting of the locking nut 4.

Another known method for adjusting the bearing play is illustrated in FIG. 2. In this example a locking nut 4 and a spacer 6 are used, the locking nut 4 being positioned on the side of the second conical roller bearing 3 farthest away from the first conical roller bearing 1. The spacer 6 is on the other side of the conical roller bearing 3 and between a shoulder 7 of the shaft 2 and the inner race 5 of the second conical roller bearing 3. Precision grinding of the spacer 6 to the correct width can ensure accurate and reproducible bearing play adjustment. The position of the inner race 5 of the bearing 3 is defined by the shoulder 7 of the shaft 2 and the spacer 6. To correct the width of the spacer by re-grinding, the bearing 3 has to be dismantled in order to access the spacer 6. This makes the process time-consuming and therefore more costly.

A purpose of the present invention is to provide an alternative shaft-bearing assembly and an alternative method for fitting a plurality of bearings on a shaft. In particular, it can be an objective of the invention to provide a shaft-bearing subassembly and a method for fitting bearings on a shaft, which enables simpler adjustment of the bearing play.

### SUMMARY OF THE INVENTION

The objective is achieved by a shaft-bearing subassembly as claimed and described below.

Preferably, the objective can be achieved by a shaft-bearing subassembly for a wind turbine transmission, wherein the shaft-bearing subassembly comprises at least one shaft, the at least one shaft being mounted by means of a first roller bearing, preferably a conical roller bearing, and a second roller bearing, preferably a conical roller bearing, wherein the first roller bearing is axially fixed and the second roller bearing is secured by means of a retaining element, and wherein
the retaining element is positioned on the side of the second roller bearing facing away from the first roller bearing, and
the retaining element has a first contact surface against which the inner race of the roller bearing is supported, and a second contact surface which is connected to an abutment on the shaft.

In this case it was recognized that the retaining element of the second roller bearing can be arranged on the side of the second bearing facing away from the first bearing. In this way, to modify the fixed position, for example to adjust the bearing play, the shaft-bearing subassembly does not have to be dismantled and in particular the second roller bearing does not have to be removed from the shaft.

The first and second contact surfaces are on the same side of the retaining element, i.e. on the side thereof that faces toward the bearing.

The first roller bearing is preferably axially fixed, in that an inner race of the first bearing is secured against displacement in an axial direction facing away from the second roller bearing. An outer race of the first roller bearing is secured in a component of the wind turbine transmission such as the transmission housing, against displacement in a direction toward the second bearing. The roller elements of the first roller bearing then secure the inner race of the first roller bearing against displacement in the direction toward the second bearing and the outer race of the first roller bearing against displacement in the direction facing away from the second roller bearing.

Correspondingly, the securing of the second roller bearing by the retaining element preferably ensures axial fixing of the second roller bearing, such that an inner race of the second bearing is secured on the shaft against displacement in an axial direction away from the first roller bearing. This is achieved in that the inner race of the second bearing is supported against the first contact surface. An outer race of the second roller bearing is secured in the above-mentioned component of the wind turbine transmission against displacement in a direction toward the first bearing. The rolling elements of the second roller bearing then secure the inner race of the second roller bearing against displacement in the direction toward the first roller bearing and the outer race of the second roller bearing against displacement in the direction away from the first roller bearing.

Furthermore, the component of the wind turbine transmission secures the outer race of the first bearing against displacement in the direction toward the second roller bearing, and the outer race of the second roller bearing against displacement in the direction toward the first roller bearing.

The abutment is part of the shaft and has the function of securing the retaining element in the axial direction, in particular in a direction facing toward the first and second bearings. For this purpose a contact surface can be designed as an abutment against which the second contact surface is supported, in particular in the axial direction.

The first contact surface, the second contact surface and the contact surface designed as an abutment are preferably directed radially, i.e. they extend perpendicularly to the rotational or symmetry axis of the shaft.

The retaining element can comprise a spacer and a fixed element, which in some embodiments of the invention are designed as a single component, i.e. the retaining element is made in one piece, or, in other embodiments of the invention, is made as two distinct parts. The spacer can be positioned between the roller bearing and the fixed element.

An advantage of a shaft-bearing subassembly according to the present invention is that the bearing play can repeatedly be set precisely. Furthermore, when necessary during assembly the spacer can always be re-ground without having to dismantle the shaft or the bearing; only the retaining element has to be taken off. Moreover, the bearing play can be adjusted from the side of the second roller bearing farthest away from the first bearing. The fixing device that fixes the first roller bearing, such as an endplate or a locking ring, need not be accessible for assembling or dismantling the fixed element.

In various embodiments of the invention the fixed element can be a nut or an endplate or some other suitable locking element known to a person familiar with the field.

The first contact surface can be formed between the spacer and the inner race of the roller bearing.

In some embodiments of the invention the second contact surface can be formed between the fixed element and the shoulder of the shaft. In other embodiments of the invention the second contact surface can be located between the spacer and the shoulder of the shaft.

In various embodiments of the present invention the shaft in the shaft-bearing subassembly can be a fast-running shaft, a slow-running shaft or an intermediate shaft.

To mount the shaft-bearing subassembly in the wind turbine transmission, the first roller bearing is pushed onto the shaft and axially fixed. In particular, the inner race of the first roller bearing is fixed against displacement in the axial direction facing away from the second roller bearing. The first roller bearing is set into the component of the wind turbine transmission. This can be done after the first roller bearing has been pushed onto the shaft and fixed in the axial direction. Alternatively, the first roller bearing can first be set into the component of the wind turbine transmission and the shaft can then be pushed through the inner race of the first roller bearing. Besides the roller bearing, the component of the wind turbine transmission ensures the axial fixing of the shaft. In particular, the component of the wind turbine transmission fixes the outer race of the first roller bearing against any displacement in the direction facing toward the second roller bearing.

The second roller bearing is then pushed onto the shaft. At the same time, during this the second roller bearing is introduced into the component of the wind turbine transmission. The component of the wind turbine transmission is designed so that besides the first roller bearing, it also axially fixes the second roller bearing. In particular, the component of the wind turbine transmission secures the outer race of the second roller bearing against displacement in the direction toward the first roller bearing.

To fix the second roller bearing as well on the shaft, the retaining element is then fitted onto the shaft. This secures the inner race of the second bearing against displacement in the direction facing away from the first bearing. The retaining element is moved far enough along the shaft, in that for example the retaining element is screwed onto the shaft, for the second contact surface to come up against the abutment.

Preferably, the retaining element is first chosen such that the shaft has a large axial play once the retaining element has been put on. According to the invention, this axial play is measured. Then, the retaining element is removed. To produce a desired axial play of the shaft or a defined prestressing of the bearing, the retaining element is now modified or replaced.

To modify or replace the retaining element appropriately, the measured axial play of the shaft is taken into account. Thus it is possible, based on the measured axial play of the shaft, to determine a geometry of the retaining element that gives the desire prestress or the desired axial play.

In a final step the second roller bearing is secured by means of the modified or replaced retaining element so that the desired prestress or the desired axial play is achieved.

The procedure described has the advantage that the desired prestress or the desired axial play can be produced independently of any dimensional deviations of the components used. Instead, any dimensional deviations present are subsumed into the measured axial play of the shaft. This in turn forms the basis for determining the required geometry of the retaining element. In this way compensation for any dimensional deviations takes place automatically. Specific measures for taking dimensional deviations into account are not needed.

The individual steps of the method described above are preferably carried out in the sequence indicated. However, that sequence is not intended to be exclusive, and the individual process steps can certainly be carried out in a different sequence.

### BRIEF DESCRIPTION OF THE DRAWINGS

It should be noted that the same indexes in the various figures refer to the same, similar or analogous elements.

FIGS. 1 and 2 illustrate shaft-bearing assemblies of the prior art.

FIGS. 3 and 4 illustrate a shaft-bearing subassembly according to an embodiment of the present invention.

FIGS. 5 to 7 show schematic illustrations of possible implementations of a shaft-bearing subassembly according to various embodiments of the present invention.

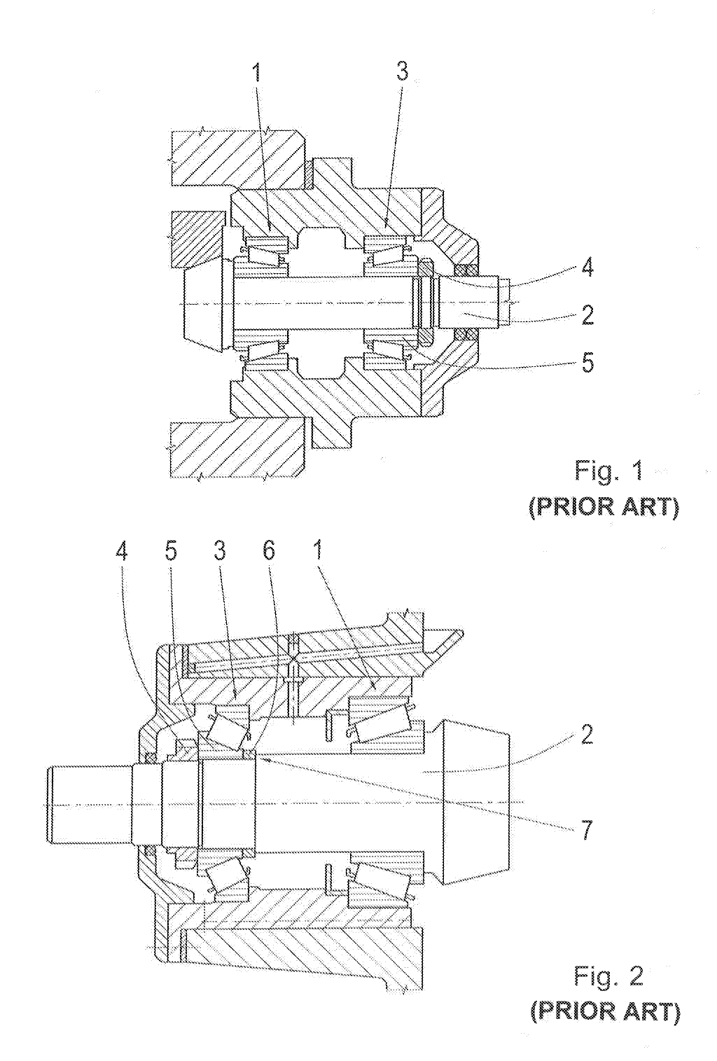

### DETAILED DESCRIPTION OF THE PREFERRED EMBODIMENTS

In the description various embodiments serve to demonstrate the invention. For that reason reference is made to various drawings. It must be made clear that the drawings are not intended to have any restrictive force; the invention is limited only by the claims. Thus, the drawings serve illustrative purposes; for the sake of clarity, the form of some elements in the drawings may be exaggerated.

The term “comprises/comprise” does not mean that besides the element said to be comprised, no other elements, in particular including further elements of the same type, may not also be comprised.

The term “connected/attached” in the claims and the description is not to be understood as a restriction to direct connections unless otherwise indicated. Consequently the expression “part A is connected to part B” is not restricted to direct contact of parts A and B, but also includes indirect contact between part A and part B; in other words it also includes the case in which intermediate components are present between parts A and B. Not all the embodiments of the invention include all the features of the invention. In the following description and in the claims, any of the embodiments claimed can be used in any desired combination.

The present invention provides a shaft-bearing subassembly for a wind turbine transmission, in particular a parallel transmission stage of a wind turbine transmission. The shaft-bearing subassembly comprises at least one shaft, which is fitted by means of two roller bearings, in particular conical roller bearings. The roller bearings can be arranged in a back-to-back configuration (O arrangement) and are fitted on the at least one shaft with axial space between them. The shaft can comprise a splined section and the roller bearings can in particular be arranged in such manner that in each case at least one roller bearing is located on one side of the splined section and at least a second roller bearing is located on the second side of the splined section. One roller bearing is axially fixed by a fixing device, such as an endplate, a locking ring or some other suitable means, and the second roller bearing is secured by means of a retaining element. The retaining element is positioned on the side of the roller bearing farthest away from the other roller bearing and has a first contact surface that is in contact with an inner race of the roller bearing, and a second contact surface that is in contact with an abutment on the shaft.

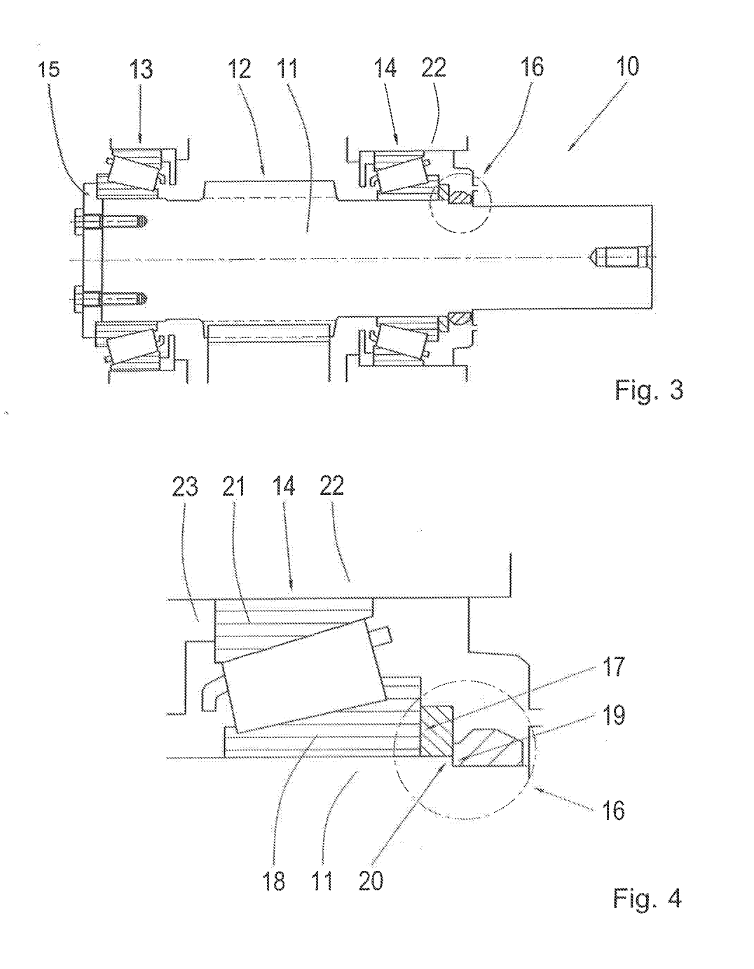

FIG. 3 shows a shaft-bearing subassembly 10 according to an embodiment of the present invention. The shaft 11 has a splined section 12. A splined section is a section on the shaft which is equipped with teeth for engaging in other teeth of some other transmission component. Furthermore the shaft 11 is mounted in two conical roller bearings 13, 14, one of which is located on each respective side of the splined section 12. In other words the splined section 12 on the shaft 11 is between the two conical roller bearings 13, 14 in which the shaft 11 is mounted to rotate. The conical roller bearings 13, 14 are fitted in a mirror-image, back to back arrangement, or in other words in an O configuration. The conical roller bearing 13 on one side of the splined section 12 on the shaft 11 is axially fixed by a fixing device 15, in the example considered by an endplate 15. The conical roller bearing 14 on the other side of the tooth engagement section 12 on the shaft 11 is positioned and adjusted by means of a retaining element 16. The retaining element is positioned on the side of the conical roller bearing 14 farthest away from the conical roller bearing 13. The retaining element 16 has a first contact surface 17 which is in contact with an inner race 18 of the conical roller bearing 14, and a second contact surface 19, which is in contact with an abutment 20 on the shaft 11 (see also FIG. 4, which shows a detail of FIG. 3). An outer race 21 of the bearing 14 is fitted in contact with a component of the transmission housing 22.

The present invention is described below with the help of various embodiments. It must be made clear that these embodiments are chosen only to facilitate an understanding of the invention, and are not intended to limit it in any way.

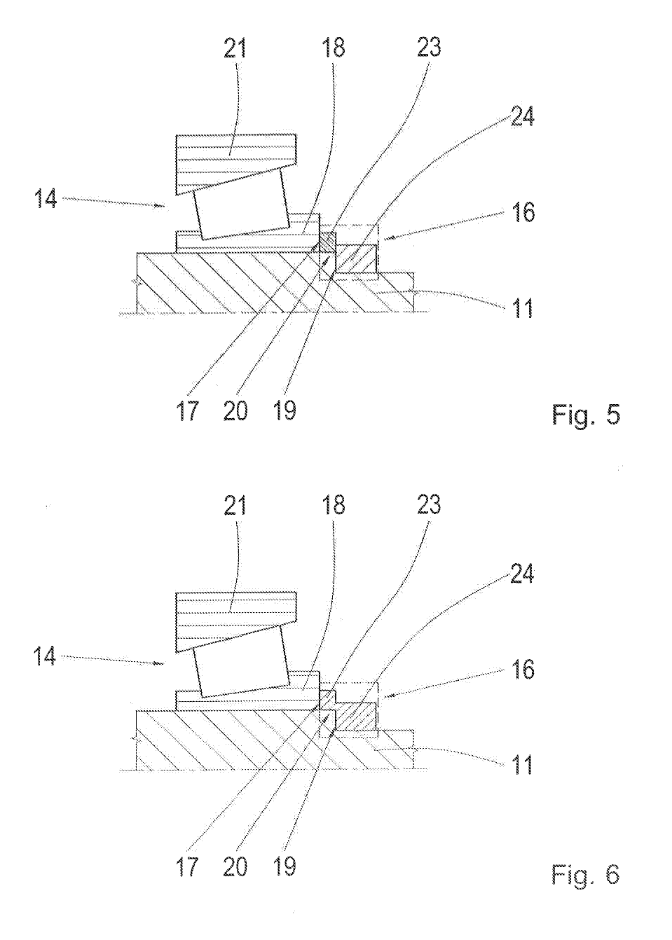

FIGS. 5 to 7 show schematic illustrations of a number of embodiments of the present invention. To simplify the explanations, the figures show only the part of the shaft 11 mounted in the bearing 14 which is in the area of the retaining element 16.

FIG. 5 shows a schematic illustration of a first embodiment of the present invention. In this first embodiment the retaining element 16 can comprise a spacer 23 and a fixing element 24. The fixing element 24 can be any desired, suitable holding device familiar to a person with knowledge of the field, such as a locking nut or an endplate. According to the present invention, the spacer 23 and the fixing element 24 can be designed as two separate components. In various embodiments of the present invention the fixing element 24 makes double contact, or in other words it has two contact surfaces. One contact is against the bearing 14, or more precisely against the inner race 18 of the bearing 14, and there is another contact against the abutment 20, i.e. the shoulder 20 on the shaft 11. In the present example the retaining element 16 has a first contact surface 17, which is in contact with the inner race 18 of the bearing 14 and is formed by one side of the spacer 23. In addition the retaining element 16 has a second contact surface 19, which is in contact with an abutment 20 on the shaft 11 and which is formed by part of the fixing element 24. The shoulder 20 defines the end position of the fixing element 24 and hence the position of the inner race 18 of the bearing 14. In some embodiments of the invention the spacer 23 is positioned between the bearing 14, or more precisely the inner bearing race 18 of the bearing 14, and the fixing element 24.

An advantage of a retaining element 16 according to embodiments of the invention is that when the bearings 13, 14 are mounted on the shaft 11, the bearing play can be adjusted easily and precisely when, in accordance with embodiments of the present invention, the retaining element 16 is fitted.

To mount a pair of conical roller bearings 13, 14 on a shaft 11 of a parallel transmission stage of a wind turbine transmission, first of all a first conical roller bearing 13 is fitted onto the shaft 11 at one end of the splined section 12. This first conical roller bearing 13 is fixed axially by means of a fixing device 15, in the example considered an endplate 15. Then, a second conical roller bearing 14 is fitted on the other side of the splined section 12. Thus, the first and second conical roller bearings 13, 14 are arranged axially on the shaft 11 with some space between them. The second conical roller bearing 14 is then secured by a retaining element 16. The retaining element 16 is positioned on the side of the second conical roller bearing farthest away from the first conical roller bearing 13, in such manner that it has a first contact surface 17 in contact with an inner race 18 of the second conical roller bearing 14 and a second contact surface 19 in contact with an abutment 20 of the shaft 11. In embodiments of the invention the first contact surface 17 and the second contact surface 19 are on the same side of the retaining element 16, i.e. on the side thereof facing toward the conical roller bearing 14.

To fit the retaining element 16, according to the present invention a spacer 23 having a defined width, preferably a little smaller than the presumed width, is first fitted. After the fixing element 24 has been fitted, the play is measured. If it is found that the bearing play adjustment is incorrect, the retaining element 16, i.e. the spacer 23 and the fixing element 24 can be taken off and a new spacer 23, this time with the correct width, and then the fixing element 24 can be fitted. It is advantageous to use a retaining element 16 according to embodiments of the present invention, since only the spacer 23 and the fixing element 24 have to be taken off and the other components, including the shaft 11 and the conical roller bearings 13, 14, do not have to be dismantled in order to be able to replace the spacer 23.

A further embodiment of the invention is illustrated schematically in FIG. 6. This embodiment is similar to that shown in FIG. 5. In the present case, however, the spacer 23 and the fixing element 24 are designed as a single component, whereas in the embodiment of FIG. 5 the spacer 23 and the fixing element 24 are designed as two separate components. In this embodiment the retaining element 16 can be fitted in a manner similar to that described for the previous embodiment, with the difference that in this embodiment the spacer 23 and the fixing element 24 are fitted and removed together since they constitute a single component. If the bearing play adjustment is incorrect, the retaining element 16 is again taken off in a similar manner and replaced with another retaining element 16 of the correct width. Another expedient for producing a better play with the present embodiment is to first fit a retaining element 16 that is too wide, then take it off again and grind down the contact surface 19 in order to obtain the correct width and therefore the correct and exact bearing play.

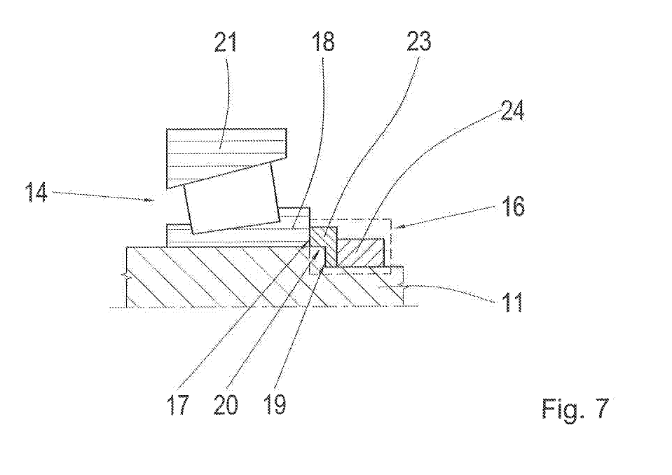

FIG. 7 shows a schematic illustration of a further embodiment of the invention. As with the embodiments described above, here too the retaining element 16 comprises a spacer 23 and a fixing element 24. The spacer 23 and the fixing element 24 are made as two separate components and the spacer 23 is positioned between the bearing 14, or more precisely the inner race 18 of the bearing, and the fixing element 24. According to the present invention the spacer 23 can be shaped as an inverted L. In other words, the spacer 23 consists of a first part with a first width and a second part with a second width, the second width being smaller than the first width. The fixing element 24 can for example be a locking nut or an endplate or some other suitable locking element known to a person familiar with the field. According to the present embodiment and in a manner similar to that described for the embodiments to which FIGS. 5 and 6 relate, the spacer 23 makes a double contact, namely one contact with the inner race 18 of the bearing 14 and the other contact with the shoulder 20 on the shaft 11. The retaining element 16 has a first contact surface 17, which is formed by a part of the spacer 23, i.e. the widest part or the part with the largest width, which is in contact with the inner race 18 of the bearing 14. In addition the retaining element 16 has a second contact surface 19, which is formed by another part of the spacer 23, i.e. the smallest part or the part with the smallest width, which is in contact with an abutment 20, in the present embodiment a shoulder 20 on the shaft 11. According to embodiments of the invention the first contact surface 17 and the second contact surface 19 are both on the same side of the retaining element 16, i.e. on the side thereof facing toward the conical roller bearing 14.

As described for the previous embodiment, an advantage of a retaining element 16 according to embodiments of the present invention is that the bearing play can be set easily and precisely. After the bearings 13, 14 have been fitted onto the shaft 11, which can be done similarly to the embodiment of FIG. 5, a retaining element 16 as described in relation to FIG. 7 is fitted. In this present embodiment, if the bearing play setting is incorrect then that side of the spacer 23 which forms the second contact surface 19 can be re-ground in order to optimize the bearing play setting.

An advantage of a shaft-bearing subassembly 10 according to embodiments of the present invention is that the bearing play can be set repeatedly with precision.

Furthermore, should it prove to be necessary during assembly, it is always possible to re-grind one side of the retaining element 16, i.e. to re-grind or replace the spacer 23 without having to dismantle the shaft 11 or the bearings 13, 14; only the retaining element 16 itself has to be removed.

Moreover, the bearing play can be adjusted from the side of the second conical roller bearing 14 that is farthest away from the first conical roller bearing. Consequently, the fixing element such as the endplate 15, which fixes the first conical roller bearing 13, does not have to be accessible in order to fit or remove the retaining element 16. In a shaft-bearing subassembly 10 according to embodiments of the present invention, the shaft 11 can be a fast-running shaft, a slow-running shaft and/or an intermediate shaft 11 of a planetary transmission stage of a wind turbine transmission.

### LIST OF INDEXES

10 Shaft-bearing subassembly
11 Shaft
12 Splined section
13 Conical roller bearing
14 Conical roller bearing
15 Fixing device
16 Retaining element
17 First contact surface
18 inner race of 14
19 Second contact surface
20 Abutment
21 Outer race of 14
22 Transmission housing component
23 Spacer
24 Fixing element

1-12. (canceled)

13. A shaft-bearing subassembly (10) for a wind turbine transmission, the shaft-bearing subassembly (10) comprising:
at least one shaft (11),
the at least one shaft (11) being mounted by at least a first roller bearing (13) and a second roller bearing (14),
the first roller bearing (13) being axially fixed and the second roller bearing (14) being secured by a retaining element (16), and the retaining element (16) being located on a side of the second roller bearing (14) facing away from the first roller bearing (13),
the retaining element (16) having a first contact surface (17) against which an inner race (18) of the second roller bearing (14) being supported, and
a second contact surface (19) being connected with an abutment (20) on the shaft (11).

14. The shaft-bearing subassembly (10) according to claim 13, wherein the retaining element (16) comprises a spacer (23) and a fixing element (24).

15. The shaft-bearing subassembly (10) according to claim 14, wherein the spacer (23) is positioned between the second roller bearing (14) and the fixing element (24).

16. The shaft-bearing subassembly (10) according to claim 14, wherein the spacer (23) and the fixing element (24) are made as a single component.

17. The shaft-bearing subassembly (10) according to claim 14, wherein the spacer (23) and the fixing element (24) are made as at least two separate components.

18. The shaft-bearing subassembly (10) according to claim 17, wherein the fixing element (24) is either a locking nut or an endplate.

19. The shaft-bearing subassembly (10) according to claim 14, wherein the first contact surface (17) of the retaining element (16) is formed by at least part of one side of the spacer (23).

20. The shaft-bearing subassembly (10) according to claim 14, wherein the second contact surface (19) of the retaining element (16) is formed by part of the fixing element (24).

21. The shaft-bearing subassembly (10) according to claim 14, wherein the second contact surface (19) of the retaining element (16) is formed between the spacer (23) and the abutment (20).

22. The shaft-bearing subassembly (10) according to claim 13, wherein the shaft (11) is at least one of a fast-running shaft, a slow-running shaft and an intermediate shaft.

23. A method of fitting a shaft-bearing subassembly (10) into a wind turbine transmission, the shaft-bearing subassembly (10) having at least one shaft (11), the at least one shaft (11) being mounted by at least a first roller bearing (13) and a second roller bearing (14), the first roller bearing (13) being axially fixed and the second roller bearing (14) being secured by a retaining element (16), and the retaining element (16) being positioned on a side of the second roller bearing (14) facing away from the first roller bearing (13), the retaining element (16) having a first contact surface (17) against which an inner race (18) of the second roller bearing (14) is supported, and a second contact surface (19) being connected with an abutment (20) on the shaft (11), the method comprising:
fitting the first roller bearing (13) and the second roller bearing (14) onto the shaft (11);
fitting the first roller bearing (13), the second roller bearing (14) and the shaft (11) into the wind turbine transmission;
axially fixing the first roller bearing (13); and
securing the second roller bearing (14) by the retaining element (16).

24. A method of fitting a shaft-bearing subassembly (10) into a wind turbine transmission and adjusting either a prestressing or an axial play of a first roller bearing (13) and a second roller bearing (14) of the shaft-bearing subassembly (10), the shaft-bearing subassembly (10) having at least one shaft (11), the at least one shaft (11) is mounted by at least the first roller bearing (13) and the second roller bearing (14), the first roller bearing (13) is axially fixed and the second roller bearing (14) is secured by a retaining element (16) and the retaining element (16) is positioned on a side of the second roller bearing (14) facing away from the first roller bearing (13), the retaining element (16) has a first contact surface (17) against which an inner race (18) of the second roller bearing (14) is supported, and a second contact surface (19) which is connected with an abutment (20) on the shaft (11), the method comprising:
fitting the first roller bearing (13) and the second roller bearing (14) onto the shaft (11);
fitting the first roller bearing (13), the second roller bearing (14) and the shaft (11) into the wind turbine transmission;
axially fixing the first roller bearing (13);
securing the second roller bearing (14) by the retaining element (16);
measuring the axial play of the shaft (11);
removing the retaining element (16);
either modifying or replacing the retaining element (16); and
securing the second roller bearing (14) by the modified or the replaced retaining element (16).
